(19) United States
(12) Patent Application Publication
(10) Pub. No.: US 2010/0030604 A1
(43) Pub. Date: Feb. 4, 2010

(54) Executing Business Rules in a Business Process

(76) Inventor: Fred A. Cummins, Pinckney, MI (US)

Correspondence Address: FISH & RICHARDSON P.C., P.O. BOX 1022, MINNEAPOLIS, MN, 55440-1022, US

(21) Appl. No.: 12/184,677

(22) Filed: Aug. 1, 2008

(51) Int. Cl. G06Q 10/00; G06N 5/02; G06Q 30/00

(52) U.S. Cl. 705/8; 706/47

(57) ABSTRACT

Systems, methods, and apparatus, including software tangibly stored on a computer readable medium, involve executing a business process. A business rules repository that stores multiple business rules is maintained. Each business rule defines logic used in one or more business processes. A business process is identified, and the business process includes business operations and an identification of one or more business rules in the business rules repository. A business rule is retrieved from the business rules repository to a business process execution module based on the identification included in the business process. The retrieved business rule is executed using the business process execution module. One or more of the business operations is identified for execution based on a result of executing the retrieved business rule. The identified business operation is executed using the business process execution module.

### BACKGROUND

This description relates to executing a business process that includes business rules.

An enterprise, such as a business, art organization, or an individual, may implement, one or more business processes for achieving objectives and/or accomplishing tasks of the enterprise. A business process can include one or mare business operations that are carried out automatically, for example, by a computing device or an information processor. Far example, an enterprise may implement business processes for collecting customer feedback, ordering assets and/or services, collecting job applications, scheduling meetings, training employees, selling goods and services, up-selling goods and services, applying for leave, allocating resources, tracking assets, and/or any other enterprise objective.

A business process may include business rules and business operations. A business operation can define or identify a business activity, such as sending and/or receiving information, generating a work product, acquiring and/or using assets, triggering other business processes, and/or other types of activities. A business rule can operate in the context of a business process, for example, to implement an enterprise policy, to enforce a regulation, and/or for another purpose. In some cases, a business rule implements analysis, computation, and/or decision logic to identify a business operation or a set of business operations for execution.

### SUMMARY

In one general aspect, a business rules repository that stores multiple business rules is maintained. Each business rule defines logic used in one or more business processes. A business process is identified, and the business process includes business operations and an identification of one or more business rules in the business rules repository. A business rule is retrieved from the business rules repository to a business process execution module based on the identification included in the business process. The retrieved business rule is executed using the business process execution module. One or more of the business operations is identified for execution based on a result of executing the retrieved business rule. The identified business operation is executed using the business process execution module.

Implementations can include one or more of the following features. The business process defines a sequence of execution for the business operations and the one or more business rules. The business rule can be retrieved when the business rule is encountered for the first time during execution of the business process, and/or before any of the business operations or business rules are executed. The retrieved business rule is executed multiple times using the business process execution module. The identification of the one or more business rules includes a line of code invoking the retrieved business rule, a uniform resource locator, a pointer to a memory address, and/or an identification of a set of business rules in the business rules repository. The set of business rules are retrieved from the business rules repository to the business process execution module based on the identification of the set of business rules. One or more of the business operations is executed after retrieving the business rule and before executing the retrieved business rule. The business process execution module includes a software application or a component of a software application. The logic defined by the business rule includes at least one of Boolean logic, a mathematical operation, or a conditional statement. The retrieved business rule can include a compiled function, and retrieving the business rule can include loading a link to the compiled function. A condition and/or a conditional statement is evaluated to identify one of the business operations for execution based on a result of executing the retrieved business rule. One or more of the multiple business operations relates to sending a message, reading a message, storing data in a machine-readable medium, and/or modifying data stored in a machine-readable medium. The business process relates to ordering a good or a service, processing a request for a good or a service, managing a workforce, managing a work flow, managing assets, communicating with customers, marketing a good or a service, analyzing business data, and/or another type of process. Retrieving the business rule from the business rules repository includes loading the business rule substantially concurrently with initiation of a runtime of the business process. The retrieved business rule and the identified business operation are executed during the runtime of the business process. The retrieved business rule is executed multiple times during the runtime of the business process. A user interface can display information related to execution of the business process. The described techniques can be implemented in methods, systems, apparatus, computer program products, or otherwise, tangibly stored on a computer readable medium as instructions operable to cause programmable processor to perform actions.

The details of one or more implementations are set forth in the accompanying drawings and the description below. Other features will be apparent from the description and drawings, and from the claims.

### DESCRIPTION OF DRAWINGS

FIG. 1 is a block diagram of an example business process system.

FIG. 2 is a signaling and flow diagram for an example business process execution system.

FIG. 3 is a flow diagram of an example process for executing business rules in a business process.

FIG. 4 is a schematic diagram of an example of a computer system.

Like reference symbols in the various drawings indicate like elements.

### DETAILED DESCRIPTION

A business process can define one or more sequences of business operations and business rules. A business operation, when executed, can perform and/or initiate business actions specified by the business operations. A business rule can make determinations about additional business actions that may be taken. For example, a business rule may identify which business operations should be executed and/or identify parameters for executing a business operation. A business process can include an identification of a business rule stored in a business rules repository. Before the business rule is executed (e.g., during startup of a business process execution module, when the business process is loaded, or at another point), the business rule definition can be retrieved from the business rules repository. The retrieved business rule definition can then be used to execute the business rule one or more times when executing the business process.

By storing the business rule definition in the business rules repository, changes to the business rule can be made quickly and efficiently, without necessarily editing individual business processes in which the business rule is included. Thus, a business rule that is used by many business processes can be modified once in the business rules repository, and the modification may be effectively propagated to all of the business processes that implement the business rule. Moreover, by retrieving the business rule definition to the business process execution module for multiple executions of the business rule by the business process execution module, data traffic and/or data conversion may be reduced. For example, executing a business process may include executing cue or more business rules multiple times. This may be a result of multiple instances of the business rule in the business process and/or multiple iterations of a portion of the business process that includes the business rule (e.g., in a loop). Retrieving the business rule definition once and executing the retrieved definition multiple times may be more efficient and/or faster than retrieving the rule definition each time the rule is executed. Retrieving the business rule definition to the business process execution module and executing the retrieved definition at the business process execution, module multiple times may be more efficient and/or faster than transmitting business rule input parameters to a separate business rules execution engine and receiving business rule output data from the separate business rules execution engine each time a business rule is executed. In implementations where the business rules repository and the business process execution module communicate over a network, network traffic may be reduced by communicating the business rule definition for repeated local execution by the business process execution module. In other implementations, data conversion, data duplication, and/or other computational overhead may be reduced by retrieving the business rule definition to the business process execution module for repeated execution by the business process execution module.

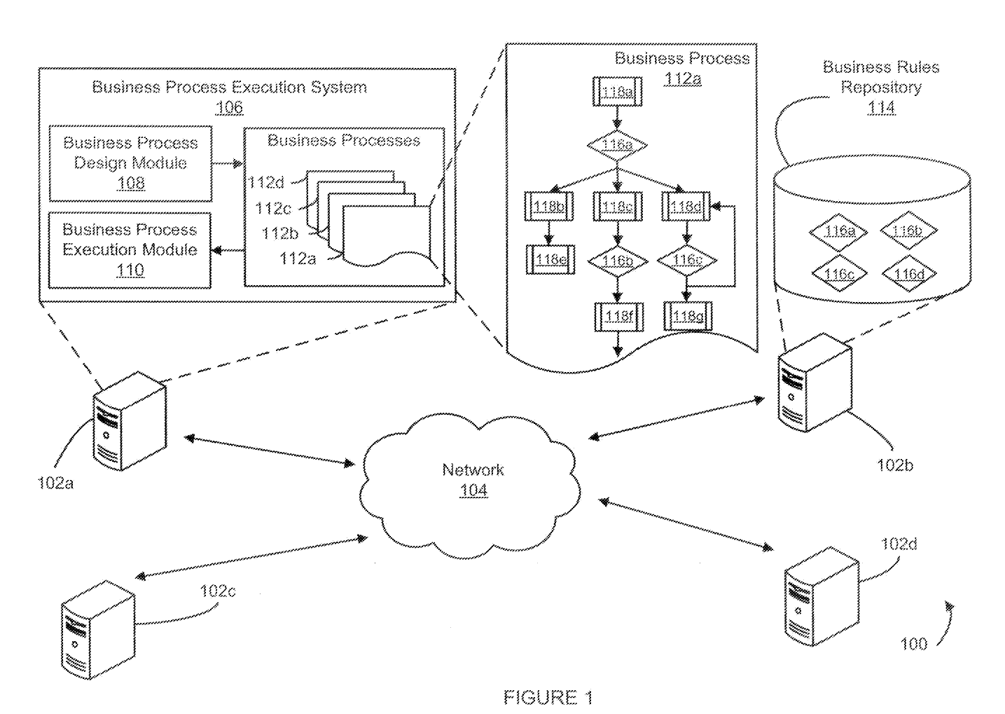

FIG. 1 is a block diagram of an example business process system 100. The business process system 100 executes business processes by loading a set of business rules into a business process execution system substantially during a runtime of the business process. Business rules are stored, maintained, and/or distributed from one or more business rules repositories 114. In some implementations, by storing, maintaining, and/or distributing business rules from a business rules repository 114, business rules may be updated and kept current more easily. In some implementations, retrieving and/or loading business rules substantially at runtime and executing them on client computers (e.g., business process execution systems 106) may reduce or eliminate the need for a centralized rules processing engine, the need for multiple separate rules processing engines, data traffic volume on a network, data conversion, data manipulation, data volume, and/or other factors.

The business process system 100 includes one or more computers, such as a computer 102a, a computer 102b, a computer 102c, and a computer 102d. The computers 102a-102d are communicably coupled through a network 104. The computer 102a includes a business process execution system 106. The business process execution system 106 includes a business process design module 108 that can be used to design business processes. The business process execution system 106 includes a business process execution module 110 that can be used to execute business processes. The computer 102a stores and/or has access to multiple business processes 112, including the illustrated example business processes 112a, 112b, 112c, and 112d.

A business process 112a defines a sequence of one or more business operations and/or business rules. In some implementations, the business processes 112a-112d can relate to various tasks that can be carried out to perform business functions. Examples of tasks that can be carried out by the business processes 112a-112d can include ordering goods and/or services, processing one or more requests for goods and/or services, managing a workforce, managing a work flow, managing assets, communicating with employees, customers, and/or other persons, marketing a good or service, analyzing business data, or performing other types of business tasks.

A business process 112 may be implemented through an automated means. A business process 112 may be written in computer-readable form for implementation by a data processing apparatus. Example computer-readable forms include electronic files, electronic documents, and others. A business process may be defined using a markup language, such as extensible markup language (XML) or another type of markup language. A business process may be defined using a different type of programming language.

An example business process 112 defines a sequence of operations for processing a life insurance policy application. In the example, a customer applies for a life insurance policy. An insurance agent enters the customer's information into an electronic application form and submits it to a processing system. The processing system processes the information through an automated business process to determine what type of rate or policy the applicant may qualify for by making one or more decisions based on the entered information (e.g., age, smoker/nonsmoker, health status, and/or others). For example, the agent may enter the customer's information and initiate an insurance qualification business process. The business process 112 can execute a business operation that reads the customer's age, health status, or other information. Once that information has been read, the business process 112 can execute one or more business rules to determine the customer's ability to qualify for a policy. For example, the insurance company may offer one policy to customers under 50 years of age, and a second policy for those who are 50 or older. The business rules perform conditional operations such as evaluating if the applicant is 50 or older, and if so, determine that the applicant qualifies for the second policy. Furthermore, the determination made by the business rule may cause the business process to branch to additional business rules and/or business operations. For example, the business process may branch to a business operation that issues the insurance policy.

In some implementations, the business process design module 108 is a software application or a component of a software application that can be used to create and/or design business processes such as the business processes 112a-112d. For example, the business process design module 108 can present a graphical user interface and allow a user to select business operations and business rules to include in a business process. The user can be a business user, a technician, or another type of user.

In some implementations, the business process execution module 110 is a software application or a component of a software application that is used to execute business processes such as the business processes 112a-112d. The business process execution module 110 can retrieve a business rule definition 116 from the business rules repository 114. The business process execution module 110 can execute the retrieved business rule 116, identifying a business operation 118 for execution based on a result of executing the retrieved business rule 116, and execute the identified business operation 118.

The computer 102b includes a business rules repository 114. The business rules repository 114 stores a collection of business rules 116a through 116d. In some implementations, the business rules repository 114 can be a file server, a database, or other system that can be used to store, locate, and provide the business rules 116a-116d to a business process execution module 110. The business rules 116a-116d may represent decisions and/or gateways that can be included in the business processes 112a-112d to be performed by the business process execution module 110. The business rules 116a-116d may represent computations and analysis that can be included in the business processes 112a-112d to be performed by the business process execution module 110.

In the illustration of FIG. 1, the business process 112a is shown in additional detail. The business process 112a includes a number of business operations 118a through 118g and the business rules 116a-116c. The business operations 118a-118g represent actions that can be performed by the business process execution module 110. For example, the business operations 118a-118g can include operations such as sending, reading, and/or storing a message, loading, saving, and/or modifying data in a machine-readable medium, printing data, interacting with a user, interacting with other computers and/or processes, executing other types of computer processes. The business process 112a may include one or more of die business rules 116 by an identifier of the business rule and/or an identifier of a subset of the business rules 116 without including a definition of the business rules 116. An identifier of a subset of the business rules 116 can be a single identifier that is used to retrieve some or all of the business rules 116.

In some implementations, the business rules 116a-116c can include Boolean logic, mathematical operations, and/or conditional statements. A business rule can involve complex computational procedures and/or relatively simple decision points. For example, the business rules 116a-116c can determine if a credit applicant qualifies for a loan by comparing the applicant's credit score against a threshold value, if the applicant's credit score is above the threshold, the applicant can be approved, otherwise the applicant can be denied. In another example, the business rules 116a-116c can compute a value, such as a depreciation value for an asset, by utilizing information about the asset (e.g., the asset's cost basis, the estimated life expectancy of the asset, the applicable recovery period, the applicable depreciation method, the purchase date, the current date, and/or others). In yet another example, the business rules 116a-116c can make a logical determination, such as whether or not to issue a payment electronically. In this example, data provided to the business rule 116a may indicate that a payee is able to accept an electronic funds transfer and determine that a business process (e.g., the business process 118b) that issues electronic payments should be executed, or if a business process (e.g., the business process 118c) that issues paper payments should be executed. In some enterprises/business rules implement guidelines and parameters within which the enterprise operates.

The business process execution system 106 can retrieve the business rules 116a-116d from the business rules repository 114. In some implementations, the business process execution system 106 loads the business rules 116a-116d substantially at runtime. For example, the business rules 116a-116d can be loaded and/or reloaded when the business process execution system 106 starts up, when the business process execution module 110 starts up, before the business operations 118a-118g and/or the business rules 116a-116d are loaded and/or executed, on a schedule (e.g., hourly, daily, weekly), or in response to other preprocessing and/or runtime conditions.

In some implementations, the business process execution module can execute one or more of the business rules 116a-116d one or more times after being retrieved from the business rules repository 114. For example, the business rules 116a-116c can be loaded from the business rules repository 114 before the business process 112a is executed. The business process execution module 110 may then execute the business process 112a multiple times without needing to re-retrieve the business rules 116a-116c. In some implementations, by executing the business process 112a multiple times without reloading the business rules 116a-116c, the amount of data traffic that is communicated through the network 104 is reduced.

In some implementations, the business rules 116a-116d can be compiled functions. For example, the business rules 116a-116d can be defined by programming codes and compiled into executable modules (e.g., an executable program (EXE), a dynamically linked library (DLL), and/or others). In examples where the business rules 116a-116d are compiled functions, the business processes 112a-112d can include a link to the compiled function. The link can be used to retrieve the compiled business rules 116a-116d from the business rules repository 114.

In some implementations, the business rules 116a-116d can be interpreted functions. For example, the business rules 116a-116d can be written in a proprietary or standard scripting language (e.g., Python, JavaScript, PERL, and/or others) that is substantially read and executed at runtime. In another example, the business rules 116a-116d can be written in a textual format, such as an extensible markup language (XML) or ASCII file.

In some implementations, the business processes 112a-112d can identify the business rules 116a-116d by a business rule identifier (e.g., a serial number, a database key, a file name, and/or others). In other embodiments, the business processes 112a-112d can identify the business rules 116a-116d by a uniform resource locator (URL) or a pointer to a memory address. For example, the business rule 116a could by identified in the business process 112a by a pathname to a physical storage location such as “\\business_rules_repository\business_rules\income_limit.rul” or by a server address such as “http://www.johndoe.com/business_rules/interest_calculations.rul”. In yet another example, the business process 112a can identify the business rule 116a by the memory address (e.g., memory location 0x00ffa1b9), where the business rule 116a is stored.

In the example of the business process system 100, the business rules execution system 106 exists on the computer 102a while the business rules repository 114 resides on the computer 102b. In some implementations, however, the business process execution system 106 and the business rules repository may coexist on a single computer. Any of the business process design module 108, the business process execution module 110, or the collection of business processes 112a-112d may be stored and/or executed on a computer other than the computer 102a. For example, the business process design module 106 may be executed on the computer 102c to create and/or modify the business processes 112a-112d that are stored on the computer 102d. The business process execution module 110 may retrieve the business processes 112a-112d from the computer 102d for execution.

In some implementations, the business process design module 108, the business process execution module 110, and/or the business rules repository 114 can expose interfaces that can be communicably coupled to remote devices. For example, the business process execution module 110 can expose an interface that can communicate with a user interface running locally on the computer 102a or on a remote computer such as the computer 102c. This interface may allow a user at the computer 102c to identify and/or initiate the execution of the business processes 112a-112d by the business process execution module 110 running on the computer 102a. The interface may also provide the user with information related to the execution of the business processes 112a-112d (e.g., percentage complete, estimated time to completion, error messages).

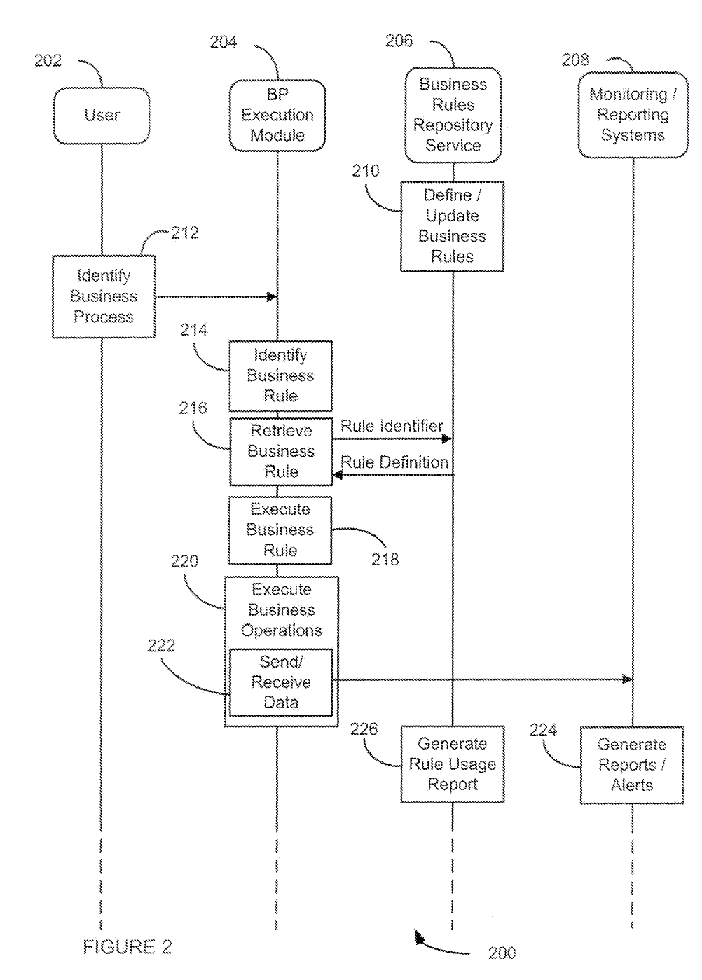

FIG. 2 is a signaling and flow diagram 200 of interactions for an example business process execution system. The diagram 200 illustrates interactions between a user 202, a business process execution module 204, a business rules repository service 206, and a monitoring and reporting system 208. In some implementations, the business process execution module 204 is the business process execution module 110. In some implementations, the business rules repository service 206 is a service provided by the business rules repository 114 to provide access to business rules, such as the business rules 116a-116d.

At 210, one or more business rules are defined and/or updated. In some implementations, the business rules can be created and/or updated using an executable software module, such as the business process design module 108.

At 212, a business process is identified for execution. In some implementations, the business process is identified by a user. For example, the user may interact with a computer interface to indicate the business process that the user wishes to have executed. In some implementations, the business process is identified automatically. For example, the business process may be identified by a scheduler for periodic execution (e.g., run hourly, daily, weekly, monthly, annually). In another example, the business process may be identified automatically by data associated with the business process. In this example, a business process may require several pieces of data, such as a part identifier, a price, a quantity, and a shipping address, before carrying out a business process that causes an order to be shipped. Data may be queued for processing until all the required information has been entered, and then identify and execute the business process.

Execution of the identified business process includes identifying, at 214, one or more business rules indicated by the business process. In some implementations, the business process specifies a business rule by a business rule identifier, and the business process execution module 204 identifies the business rule based on the identifier. The identifier may include, for example, a business rule name, a file location, a file name, a database key, a memory location, or other unique identifier that can be used to identify a business rule stored in the business rule repository service 206.

At 216, the identified business rule is then retrieved from the business rules repository service 206. In the illustrated example, the business rule is retrieved by sending a request that includes a rule identifier to the business rules repository service 206, and by the business rules repository service 206 sending a business rule definition in response. In some implementations, the process of rule identification and retrieval can be an interaction with a file system, a database query, or other computerized interaction that may be used to retrieve 216 an identified business rule. In some implementations, the business rule repository service 206 is a web service. For example, the business rules repository service 206 may present a HTML-based interface that is compliant with the Simple Object Access Protocol (SOAP). The business process execution module 204 may send the identifier of the business rule identified at 214 to the business rules repository service 206 as part of an HTTP server request. The business rules repository service 206 may respond to the request by sending the rule definition as part of an XML based response document.

At 218, the business process execution module 204 executes the retrieved business rule. In some implementations, the business process execution module 204 executes the business rule one or more times without requiring that the business rule be retrieved again. For example, the business rule may be retrieved when the business process is loaded, and used repeatedly until, the business process or the business process execution module's execution is terminated. In another example, the business rule, once retrieved, may remain available for use for a period of time (e.g., a minute, hour, day, or another amount of time) before being unloaded or reloaded. In yet another example, the business process execution module 204 may cache business rules, wherein business rules that are used infrequently may be unloaded, whereas more frequently used business rules may be retained locally (e.g., to avoid the overhead of repeatedly re-retrieving them). The business process and/or each of the business rules may be executed multiple times based on the retrieved business rule. Thus, the business rule does not necessarily need to be retrieved each time the business process and/or the business rules are executed.

At 218, execution of the business rule determines which business operation(s) are to be subsequently executed at 220. In the illustrated example, execution of the business operation includes sending and/or receiving data (222). The data is sent to the monitoring and/or reporting system 208. The data may indicate, for example, a result of applying the business rule one or more times during one or more executions of the business process. For example, the data may indicate a number of loan applications accepted and/or rejected over a period of a period of time and/or over a number of executions. In some cases, a business rule can be implemented in a reporting mode, such that the effects of the business rule can be observed and/or analyzed before the business rule is used in production. At 224, using the sent data and/or other data, the monitoring and/or reporting system 208 generates reports and/or alarms based upon the data. At 226, the business rules repository service 206 generates a rule usage report. The business rule may generate data causing an alert, to be reported by the monitoring and/or reporting systems 208.

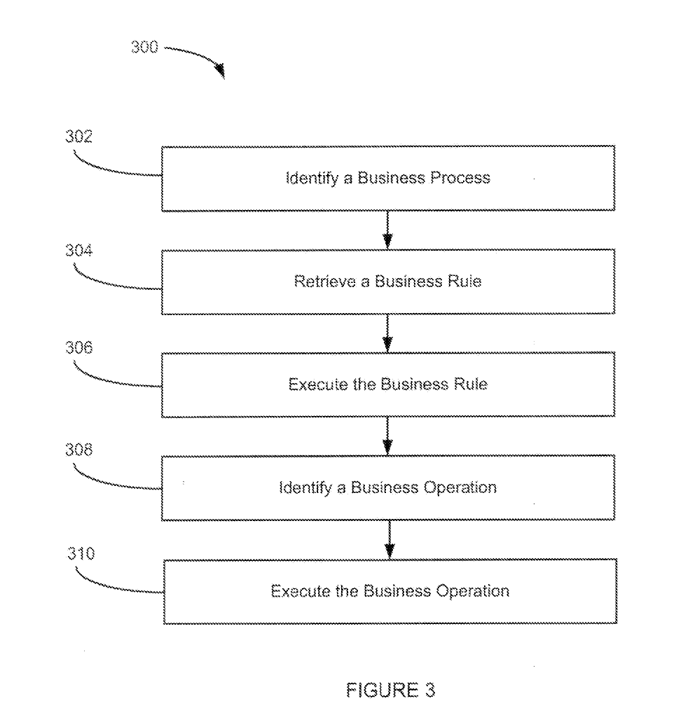

FIG. 3 is a flow diagram, of an example process 300 of identifying and executing business rules and operations. In some implementations, the process 300 is carried out by the business process execution system 106 of FIG. 1. At 302, a business process is identified. In some implementations, the identification of a business process can be done by a user interacting with the business process execution system (e.g., the user manipulating a user interface), by an automated process (e.g., a scheduled process), or by another process that may be used to identify a business process.

At 304, one or more business rules identified by the business process are then retrieved. In some implementations, the business rule is identified in the business process by a line of code that invokes the business rule. In some implementations, the business rules are retrieved from a business rules repository such as the business rules repository. At 306, after the business rule is retrieved, the business rule is executed. In some implementations, the business rule can be executed one or more times as directed by the business process without being re-retrieved.

Based on a result of executing the business rule, a subsequent business operation is identified (at 308) and executed (at 310). For example, the business process may include steps for sending a message to a customer, wherein some customers prefer to be contacted by email and others prefer to be contacted via postal mail. In this example, the business rule may have access to data that describes the customer's contact preferences, and determine if the customer should be contacted by email or postal mail. Based upon this data, the business rule may determine whether a business operation that initiates the sending of an email message, or a business operation that initiates the sending of a postal mail message, should be subsequently identified (308) and executed (310).

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled, or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or mom mass storage devices for storing data, e.g., magnetic, magneto optical, disks, or optical disks. Information carriers suitable for embodying computer program instructions and data include all forms of eon volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

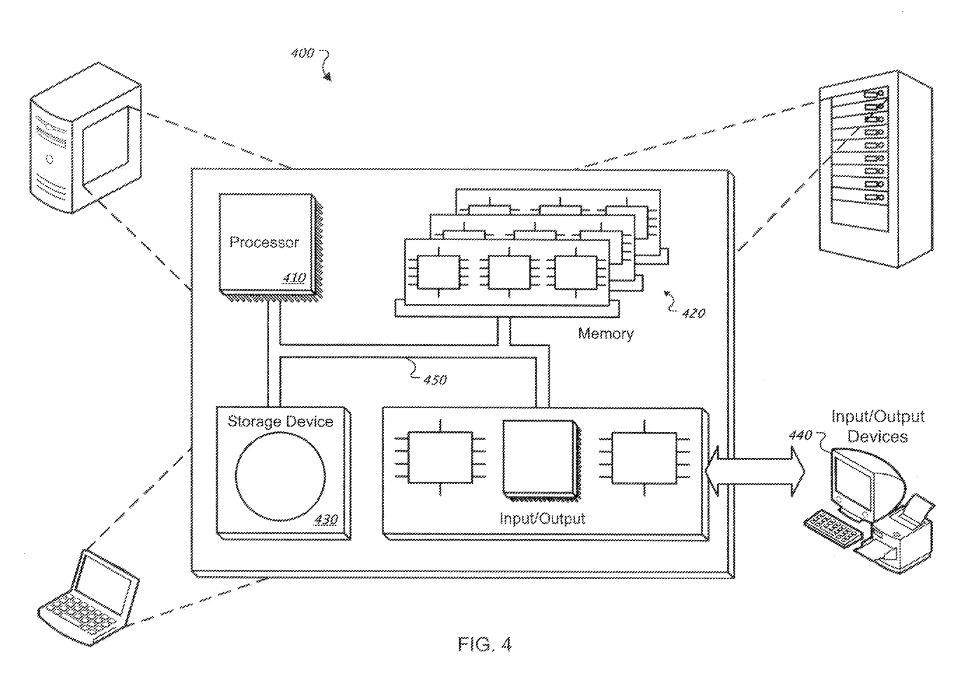

FIG. 4 is a schematic diagram of an example of a generic computer system 400. The system 400 can be used for the operations described in association with the method 300 according to one implementation. For example, the system 400 may be included in either or all of the client A 104, the client B 106, the server 104, the news server 220, and the e-mail server 230.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard, disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital, data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described, flows, and other components may be added to, or removed from, the described systems. Accordingly, other implementations are within the scope of the following claims.

A number of embodiments of the invention have been described. Nevertheless, it will, be understood that various modifications may be made without departing from the spirit and scope of the invention. Accordingly, other embodiments are within the scope of the following claims.

What is claimed is:

1. A method of executing a business process, the method comprising:
maintaining a business rules repository comprising a plurality of business rules, wherein each business rule defines logic used in one or more business processes;
identifying a business process comprising a plurality of business operations and an identification of at least one business rule in the business rules repository;
retrieving a business rule from the business rules repository to a business process execution module based on the identification included in the business process;
executing the retrieved business rule using the business process execution module;
identifying one of the business operations for execution based on a result of executing the retrieved business rule; and
executing the identified business operation using the business process execution module.

2. The method of claim 1, wherein the business process defines a sequence of execution for the plurality of business operations and the at least one business rule.

3. The method of claim 1, wherein the retrieved business rule is retrieved before any of the business operations or business rules are executed.

4. The method of claim 1, further comprising executing the retrieved business rule a plurality of times using the business process execution module.

5. The method of claim 1, wherein the identification comprises a fine of code invoking the retrieved business rule.

6. The method of claim 1, wherein the identification comprises at least one of a uniform resource locator or a pointer to a memory address.

7. The method of claim 1, wherein the identification comprises an identification of a set of business rules in the business rules repository, and wherein retrieving a business rule from the business rules repository to the business process execution module comprises retrieving the set of business rules from the business rules repository to the business process execution module based on the identification of the set of business rules.

8. The method of claim 1, further comprising executing at least one of the business operations after retrieving the business rule and before executing the retrieved business rule.

9. The method of claim 1, wherein the business process execution module comprises a software application or a component of a software application.

10. The method of claim 1, wherein the logic defined by the business rule comprises at least one of Boolean logic, a mathematical operation, or a conditional statement.

11. The method of claim 1, wherein the retrieved business rule comprises a compiled function, and wherein retrieving the business rule comprises loading a link to the compiled function.

12. The method of claim 1, wherein identifying one of the business operations for execution based on a result of executing the retrieved business rule comprises evaluating at least one of a condition or a conditional statement.

13. The method of claim 1, wherein one or more of the plurality of business operations relates to at least one of sending a message, reading a message, storing data in a machine-readable medium, or modifying data stored in a machine-readable medium.

14. The method of claim 1, wherein the business process relates to at least one of ordering a good or a service, processing a request for a good or a service, managing a workforce, managing a work flow, managing assets, communicating with customers, marketing a good or a service, or analyzing business data.

15. An article comprising a machine-readable medium storing instructions for causing data processing apparatus to perform operations comprising:
identifying a business process comprising a plurality of business operations and an identification of at least one business rule stored in a business rules repository, where in the business rules repository stores a plurality of business rules and each business rule defines logic used in one or more business processes;
retrieving a business rule from the business rules repository to a business process execution module based on the identification included in the business process;
executing the retrieved business rule using the business process execution module;
identifying one of the business operations for execution based on a result of executing the retrieved business rule; and
executing the identified business operation using the business process execution module.

16. The article of claim 15, wherein retrieving the business rule from the business rules repository comprises loading the business rule substantially concurrently with initiation of a runtime of the business process, and wherein the retrieved business rule and the identified business operation are executed during the runtime of the business process.

17. The article of claim 16, wherein the machine-readable medium stores instructions for causing one or more processors to perform further operations comprising executing the retrieved business rule a plurality of times during the runtime of the business process.

18. A system for executing a business process, the system comprising:
a first interface to receive an identification of a business process, the business process comprising a plurality of business operations and an identification of at least one of a plurality of business rules stored in a business rules repository;
a second interface to retrieve data from the business rules repository based on the identification included in the business process;
a business process execution module to execute business rules retrieved using the second interface, to identify one of the business operations for execution based on a result of executing the retrieved business rule, and to execute the identified business operation.

19. The system of claim 18, further comprising a third interface to display information related to execution of the business process.

20. The system of claim 18, wherein the first interface comprises a user interface.

21. The system of claim 18, wherein at least one of the first interface or the second interface comprises a communication interface communicably coupled to a remote device.
